(19) United States
(12) Patent Application Publication
(10) Pub. No.: US 2008/0133816 A1
(43) Pub. Date: Jun. 5, 2008

(54) Goal shielding interface

(75) Inventor: Robert Hurling, Sharnbrook (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/633,808

(22) Filed: Dec. 5, 2006

(51) Int. Cl. G06F 12/00; G06Q 30/00

(52) U.S. Cl. 711/100; 705/14; 711/E12.001

(57) ABSTRACT

A computer interface and a method of operating the same for interacting with a user to improve the user's ability to sub-consciously shield an identified goal, such as eating healthily, taking regular exercise and studying for exams. The method comprising presenting the user with a series of stimuli, each stimulus suitable for prompting a response from the user, and monitoring the user's responses to the stimuli. The method further comprising determining, as a function of the responses, whether the user's behaviour is consistent with shielding the goal and presenting the user with one or more rewards dependent on the degree of shielding exhibited by the user. The computer interface and method are particularly suited for implementation on mobile computing devices, such as mobile phones and PDAs, as well as within Internet web browsing environments.

The present invention relates to behavioural training and interactive devices, and in particular relates to cognitive methods and interfaces for improving a user's ability to shield identified goals.

It is known that human attitudes towards performing a particular behaviour or activity, such as exercising regularly, maintaining a healthy diet or studying for exams, are dependent upon how effectively an individual is able to mentally shield the goal from other competing activities (e.g. such as watching TV or eating ‘fatty foods’ etc.) and/or external influences (e.g. advertisements or negative peer pressure).

Recent research suggests that the underlying processes at play when individuals attempt to change their behaviour involves the use of associations outside of everyday mental awareness. Therefore, the ability to shield a goal appears to operate outside of conscious awareness, such that a user's sub-conscious inclination towards performing a competing activity is significantly lower in individuals who are effective at goal shielding. Consequently, such individuals are more likely to engage in corresponding target behaviours, such as jogging or going to the gym etc.

Those individuals who are not effective at goal shielding are more likely to fail in their goals as they are less inclined to engage in target behaviours. In such situations a ‘goal conflict’ can arise which reduces the likelihood that an intention (e.g. to exercise) will lead to a corresponding behaviour (e.g. jogging). The goal is the motivational source for the intention (e.g. goal (get fit)→intention (exercise)→behaviour (jogging)), and it is found that goal conflicts may be experienced at both a conscious level as well as a sub-conscious level. The emergence of a goal conflict is problematic to an individual, as generally this may prevent them from enacting their intentions to undertake a particular target behaviour.

Behavioural attitudes and goal conflicts may be assessed in laboratory environments and using dedicated Internet-based algorithms, available via the World Wide Web. However, although such assessments are instructive and indicative of an individual's attitude towards performing particular behaviours they do not generally offer any form of guidance or training as to how to improve the user's goal shielding ability.

Therefore, although differences in behavioural attitudes and goal conflicts may be identified, the individual is offered no incentive or reward to resolve the differences and conflicts, so as to improve their effectiveness at shielding goals from competing activities and external influences.

Hence, in accordance with the present invention a reward-based training environment is provided for interacting with an individual to improve his/her effectiveness at goal shielding. By providing rewards, in recognition of performance, it is possible to engender greater confidence in the individual's ability, both on a conscious and a sub-conscious level, such that their effectiveness at shielding their goals is enhanced as more training exercises are completed.

An object of the present invention is to provide a method of computer-based training to a user to improve their sub-conscious ability and effectiveness at shielding identified goals.

Another object of the present invention is to provide a reward-based method of computer-based training to a user that provides rewards contingent upon the degree of goal shielding ability exhibited by the user.

Another object of the present invention is to provide a computer interface that can present a series of stimuli to a user to determine whether the user's behaviour is consistent with shielding an identified goal to thereby reward the user according to their behaviour.

Another object of the present invention is to provide a method of computer-based training to a user that can assess the efficacy of the training by testing the user prior to and following a series of training exercises.

Some or all of the above objects may be obtained by one or more embodiments of the invention.

According to an aspect of the present invention there is provided a method of operating a computer interface for interacting with a user to improve the user's ability to shield an identified goal, comprising:
presenting the user with a series of stimuli, each stimulus suitable for prompting a response from the user;
monitoring the user's responses to the stimuli;
determining, as a function of the responses, whether the user's behaviour is consistent with shielding the goal; and
presenting the user with one or more rewards dependent on the degree of shielding exhibited by the user.

According to another aspect of the present invention there is provided a computer interface for interacting with a user to improve the user's ability to shield an identified goal, comprising:
means for presenting the user with a series of stimuli, each stimulus suitable for prompting a response from the user;
means for monitoring the user's responses to the stimuli;
means for determining, as a function of the responses, whether the user's behaviour is consistent with shielding the goal; and
means for presenting the user with one or more rewards dependent on the degree of shielding exhibited by the user.

According to another aspect of the present invention there is provided a remote server for communicating with a computer interface, comprising:
means for receiving information from the computer interface;
storage means configured to store test related content; and
means for selecting one or more of the test related content, based on the received information, to be downloaded to the computer interface for improving the goal shielding ability of a user using the interface.

Embodiments of the present invention will now be described in detail by way of example and with reference to the accompanying drawing in which:

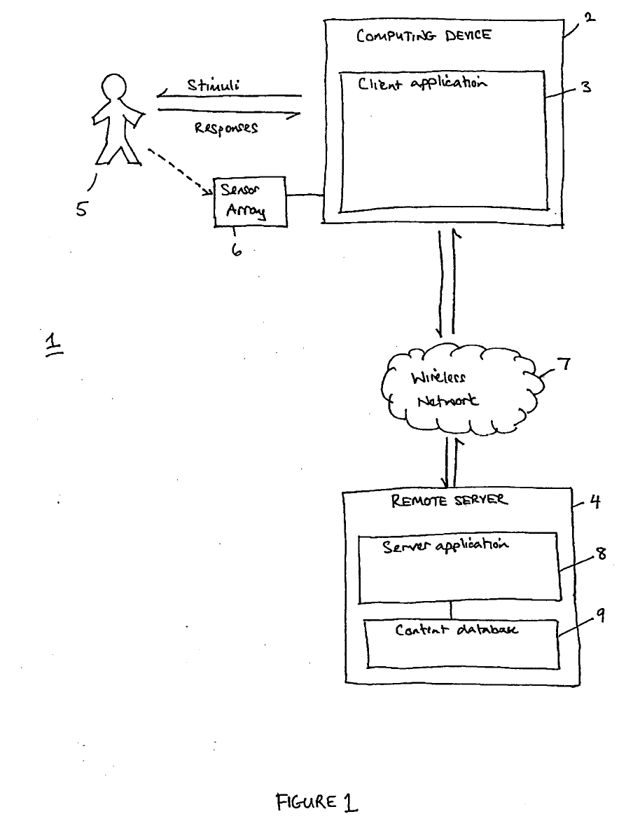

FIG. 1 is a schematic view of a preferred arrangement of a goal shielding computer interface according to the present invention.

With reference to FIG. 1, there is shown a goal shielding computer interface 1 according to a preferred arrangement of the present invention implemented on a computing device 2. The computing device 2 may be either a computer terminal (e.g. a desktop PC) or a mobile device, such as a mobile telephone, a personal digital assistant (PDA), laptop PC or a tablet PC etc.

The computer interface 1 (hereafter “the interface”) is preferably implemented via software as a client application 3. In preferred arrangements the client application 3 may be a standalone application (e.g. .EXE) running within the operating system environment or else may be an embedded applet (e.g. Java) running within a web browsing environment (e.g. Firefox, Netscape Navigator or Internet Explorer).

Alternatively in other arrangements, the interface 1 may be in the form of both software and hardware comprising the computing device 2, or else be attached to, or be an integral part of the computer terminal or mobile device etc. In these arrangements, it is to be understood that the client application 3 executes on the hardware.

It is to be appreciated therefore that the interface 1 of the present invention may be implemented in numerous ways across many different platforms, operating systems and technologies, within both permanent and mobile computing environments.

In preferred arrangements, the interface 1 also comprises a remote server 4 adapted for communication with the client application 3. By ‘remote’ we mean that the computing device 2 and the server 4 are physically separated and are disposed in different locations with respect to each other.

In most preferred arrangements, it is intended that the client application 3 will be installed on the computing device 2 by remotely accessing a suitable software repository (located on the remote server 4 or other suitable server database), and then downloading the client application 3 to the computing device 2.

Alternatively, the client application 3 may be directly installed on the computing device 2 by inserting a suitable media (e.g. CD-Rom, DVD, Compact Flash, Secure Digital card etc.) containing the application into the device 2.

In other arrangements, the client application 3 may be pre-installed on the computing device 2 during manufacture, and would preferably reside on a ROM (read only memory) chip or other suitable non-volatile storage device or integrated circuit.

In accordance with the present invention, the interface 1 is operable to provide training exercises to a user 5, so as to improve his/her ability to shield identified goals, such as eating healthily, taking exercise and studying for exams etc. The training exercises involve presenting the user 5 with a series of stimuli, each stimulus suitable for prompting a response from the user 5, and determining from those responses whether the user's behaviour is consistent with shielding the goal. If the user 5 exhibits a high degree of goal shielding, their performance will be rewarded, however if they display poor shielding abilities they will receive little or reduced reward for their efforts.

In this way, the interface 1 motivates the user 5 to perform better in successive exercises by training them to shield their goals more effectively, so as to receive greater rewards and incentives for their continuing psychological development. It is to be expected that after a period of training with the interface 1, an average user's ability to sub-consciously shield goals is significantly enhanced, giving the user a greater confidence to achieve their goals by performing target behaviours.

The training exercises can take many different forms, but they all preferably share the same underlying principle of stimulating the user 5 to respond at a level that does not necessarily require conscious awareness. In other words, the exercises are designed to test the user's sub-conscious responses to stimuli so as to cognitively probe and enhance their goal shielding ability.

In accordance with the present invention, the training exercises may be installed at the same time as the client application 3, and therefore may form part of a pre-coded set of data which is stored locally on the computing device 2. However, in preferred arrangements, the exercises may be downloaded from the remote server 4, as and when required by the user 5. In this way, the user 5 can be assured that the most up-to-date versions of the exercises are available, which also reduces the burden on the computing device's storage means, as only those exercises relating to the user's identified goals need be downloaded.

The training exercises may be in any suitable file format, such as .EXE executables, applets, pre-compiled data files or DLLs etc. which may be invoked by the client application 3, and can be compressed for retrieval and storage efficiency.

By ‘stimuli’ we mean any suitable means for prompting a response from the user 5. Hence, the stimuli may be visually presented as symbols, graphics, pictures and words etc., or alternatively may be presented audibly, as verbal speech, high/low tones, sound bites or music etc. A combination of both techniques may also be used.

Therefore, it is to be understood that any means which can provoke either a conscious or subconscious response, or reaction, from the user 5 may be used in accordance with the present invention. Thus, in some arrangements it is also possible to use scents or smells, vibrational devices (e.g. as used in mobile phones), electrical discharge devices (e.g. low voltage ‘shock-buzzers’) or even tastes to prompt the user 5 to respond.

Of course the particular stimuli used and the method of delivery/presentation to the user 5 will depend largely upon the functionality of the computing device 2 and on how the interface 1 has been implemented.

In accordance with a particularly preferred arrangement, one training exercise is based on a word categorisation test. According to this arrangement the series of stimuli correspond to words which are presented via a display device associated with the computing device 2, e.g. a TFT/LCD screen on the computer terminal or the mobile device. The user 5 is required to categorise the words according to which category they belong to, wherein a reward system is based on how well the user 5 performs in this task.

Preferably two ‘response keys’ are designated on the computing device 2, each of which correspond to a particular category into which words must be placed. The nature of the response keys will vary depending on the computing device, but in the case of a mobile phone for instance the ‘*’ and ‘#’ buttons on the keypad could be selected. Alternatively, the left and right-click buttons on a computer mouse may be used, as well as designating respective zones on a touch-sensitive screen etc.

It is also possible that a purpose-built or custom hand controller could be connected to the computing device 2, having coloured buttons, e.g. red and yellow, corresponding to a respective word category.

The client application 3 executes the word categorisation test by presenting successive words to the user 5, whereupon the user 5 selects the category to which the word belongs by pressing the respective response key. In this particular test, the rewards correspond to numerical points which are awarded for correctly categorising each word. However, to invoke a spontaneous response from the user 5, a ‘response window’ is used, based on a set of successive time periods, in which to perform each word categorisation.

In a preferred scenario, a target word is displayed together with a ‘−1’ shown in red font. The user 5 is instructed that if they do not respond within the time period in which the ‘−1° is shown, they will lose 1 point. However, if they do respond within this time, the ‘−1’ point will be converted to ‘0’ points and no penalty will be applied for a slow response. Moreover, if they answer correctly, regardless of the time taken to respond, they gain 5 points which is shown as a ‘5’ in blue font throughout the time the target word is displayed. However, points are only awarded up to a ‘time-out limit’, whereupon the user 5 receives no points for any answer after this time and the exercise continues with the next word in the series.

Hence, in a general sense the exercise provides 3 separate time periods for monitoring the user's responses, such that if a correct response (i.e. a correct categorisation of a target word) is provided by the user 5 within a first period t₁, the user 5 is rewarded with the highest reward or points. If however, the user 5 correctly responds within a second period t₂, following the first period t₁, then they are rewarded with reduced rewards or points. Any responses occurring within the third period t₃, corresponding to the period after the time-out limit, will not gain any rewards or points, whether they are correct or not.

In accordance with the principles of the exercise, the duration of the first period t₁ is made sufficiently short that there is a significantly increased likelihood that the user 5 will make an error in their response, in which case no reward or marks will be obtained. It is apparent therefore that the first period t₁ can be varied dependent on the complexity of the task, so that if the task is relatively simple the first period t₁ can be reduced accordingly, and vice versa.

According to this preferred scenario, the word categorisation test comprises 3 sets of 4 blocks, each having 50 words for categorisation. In addition to this, the first set also includes an initial practice block of 10 words, to allow the user 5 to become acquainted with the exercise. Preferably, there is a spacing interval of 1200 ms between displaying each word in a block and each word is displayed up to the time-out limit of 1500 ms. Hence, the user 5 must respond within this time-out limit.

An example of a typical word categorisation test is shown below, indicating the sorts of categories which are suitable for this exercise. During the exercise, a reminder of which categories are associated with each response key is displayed to the user at the top of the display device throughout each word test.

### Set 1:

Practice block: objects vs. names

Block 1-4: fruit vs. clothes

### Set 2:

Block 1-4: birds vs. flowers

### Set 3:

Block 1-4: transport vs. trees

The user 5 is informed to take a 1 minute break between attempting each Set, but all Sets 1-3 are to be completed within the same exercise, with the time taken to respond to each word being determined by the client application 3.

An advantageous feature of the interface 1 is its ability to adapt to the response characteristics of the user 5. In this way, it can then better customise the training exercises to the user 5, thereby further enhancing the user's learning experience. In this respect, the client application 3 can vary the time periods t₁ and t₂ for receiving the user's response in the word categorisation test, so as to compensate for any users having slower than expected responses. Preferably, the first period t₁ is set at 350 ms and therefore the ‘−1’ penalty remains displayed throughout this period. If during the. exercise it is discovered that the user 5 is repeatedly struggling to answer within this period, then the first period t₁ can be slightly extended to give the user 5 a better chance of obtaining a higher score. However, the user 5 might not be informed of this feature.

It is to be remembered that the present invention is a training aid and therefore it is not intended to demoralise or de-motivate the user 5 in any way by punishing poor performance. Therefore, it will always adapt the tests to the give the user 5 a better chance to complete the exercises, while still providing improvements in the user's goal shielding effectiveness.

Of course, as the user's ability improves during training, the first period t₁ can be shortened again so as to approach the 350 ms period. Preferably, the first period t₁ can be varied between 300 ms up to 400 ms, depending on the complexity of the task. The second period t₂ is varied accordingly.

The duration for display of the blue ‘5’ points symbol can also be varied without the user's knowledge by the client application 3. This is to provide greater incentive for attaining the highest marks in each test. Therefore, for example, the ‘5’ is displayed for 500 ms for tests within Block 1 and for 200 ms for tests within Blocks 2-4.

Preferably after each Block is completed, the user 5 is prompted to calculate their numerical score based on their performance. The client application 3 provides the user 5 with the percentage of correct responses and the percentage of responses within the first and second periods t₁ and t₂. This may best be achieved by presenting the user with a ‘calculation sheet’ to assist with determining their score. It is believed that the effectiveness of the training is improved if the user 5 performs a self-assessment of their score, as it provides a further opportunity for interaction with the interface 1. However, in other arrangements it is possible that the client application 3 could automatically maintain and provide a score to the user 5, so that manual calculation is not required—which could be advantageous in mobile computing environments where the user 5 wants to maintain a high degree of mobility, e.g. in a commuting scenario.

The purpose of the word categorisation test is for the user 5 to obtain as many points as possible throughout the exercise. However, due to the manner in which the points are awarded, the user 5 is better placed by being as accurate as possible rather than trying to respond as quickly as possible, as a rapid wrong answer gains no points, while slower correct answers will gain more points overall. The first period t₁ of 350 ms makes it very difficult for the user 5 to perform better than at a chance level and thus the points gained by being fully accurate—which can be achieved only by slowing down responses and responding within the second period t₂—offset the points gained by responding quickly.

Hence, in this exercise the user 5 is trained to sub-consciously suppress the inclination to respond quickly so that they may respond accurately. Therefore, throughout the exercise the user's ability to shield the goal of performing well (i.e. obtaining high marks) is enhanced over the sub-conscious inclination to do the competing behaviour of responding quickly. In this way, the user 5 trains their mind to focus on the goal and to shield it from conflicting influences.

It is to be appreciated that the word categorisation test described above is only one example of an exercise in which the user may improve their goal shielding ability. Therefore, many variations may be made to this test to invoke different training paradigms and methodologies. In particular, the words may be replaced by symbols or pictures or sounds etc. and the number of categories and category types may all be altered depending on the exercise and the user 5 to be trained.

Moreover, it is also possible that the responses from the user 5 could alternatively be supplied as verbal instructions, instead of depressing appropriate response keys. Therefore, some exercises could be completely verbal in nature, depending on the functionality of the computing device 2, as both the stimuli and the responses could be presented and received via audio devices.

The rewards can most simply be numerical scores, as discussed above, or alternatively may be other pleasurable incentives, such as pictures, animations, short videos, music, pleasant sounds or even scents/tastes etc. Of course, any combination of these may also be used. Hence, for example, if the user 5 attains a numerical score within a certain range, his/her favourite ring-tone or MP3 file will be played to reward their performance in the exercise.

It is also possible that the rewards could take the form of motivational messages, e.g. synthesised/recorded speech, so as to complement the user 5 on their performance and progress to date.

Variations of scoring levels are also possible and these may be adapted to the user 5 on the basis of their responses. In this way, the rewards can be optimised for the particular user 5 so as to present them with incentives for performance which are most suited to them. For example, a male user may prefer to receive football related pictures in recognition of his high test scores, while a female user might want to hear MP3 files of her favourite ‘boy band’.

Throughout the exercises other forms of penalty may be imposed, in addition to, or as an alternative to, deducting numerical points. Hence, in a similar manner to presenting rewards, penalties may also be imposed on the user 5 by way of symbols, pictures, videos or sounds etc. For example, a synthesised/recorded speech could inform the user 5 that their performance is below the average for most users at this stage of the exercise etc.

In accordance with the present invention, the interface 1 is also operable to present training exercises in a number of different ‘game-like’ virtual environments. By ‘game-like’ we mean computer generated environments driven by a conventional game engine, in which a series of visual and/or audible stimuli are presented to the user 5 to invoke a corresponding response.

In a particular example, the environment corresponds to a road race-track or road network. The user 5 is represented by a cyclist who must navigate the road from beginning-to-end without incurring penalties, while aiming to receive rewards both along the way and upon completion of the journey. Any suitable control device can be used to control the motion and direction of the virtual cyclist, such as a computer mouse, designated keys (cursor up/down left/right etc.) or a joystick etc.

The cyclist must progress around the road within an allotted time period, otherwise they will not be allowed to move onto the next level, which again involves a time trial for that course, and so on until the exercise is completed. However, the cyclist is informed that the road suffers from extreme and unexpected subsidence, so that at any moment a hole can appear into which the unsuspecting cyclist may fall. The only way to avoid the holes is to concentrate on the road and navigate around them as and when they appear. If the cyclist falls into a hole he/she will suffer a time penalty (e.g. +5 seconds). If the user 5 accumulates too many time penalties he/she will not complete the course in time and must begin again.

Throughout the course the user 5 will be exposed to a number of stimuli, some will correspond to transient messages on the screen (e.g. speed, wind direction, distance travelled), some will be icons (e.g. progress around course map) and some will be virtual objects along the roadside, e.g. animated billboards, people waving, cats and dogs running across the screen etc. Some of the stimuli will be useful to the user (e.g. speed, course progress etc.) while many stimuli will serve only to distract the user from completing the course on time (e.g. billboard signs). Hence, a key measure in determining whether the user's behaviour is consistent with effective goal shielding is assessing the degree to which the user pays attention to each of the useful and distracting stimuli. By ‘degree’ we mean how long and to what extent the user spends looking at and/or considering the stimuli.

Therefore, the user 5 must shield the goal of concentrating on the road and considering only useful stimuli from the competing behaviour of wanting look at distracting influences. Any tendency to spend time viewing distracting stimuli, such as billboards etc., will almost certainly result in falling into a newly created hole in the road, which reduces the likelihood that the cyclist will complete the course in time.

The distractions can be customised to the particular user 5 so that the distracting stimuli perform a function in their own right. Therefore, if the user 5 has a weight problem and has selected this exercise to improve their effectiveness at shielding their dieting goals, the distracting stimuli (e.g. message and billboards etc.) can convey food related slogans (e.g. “yummy cakes”, “juicy hotdogs”) and/or pictures of doughnuts, fries and burgers etc. Hence, in this way the user 5 can be trained via this exercise to sub-consciously ignore all tendencies to be distracted by food and food related marketing techniques, so as to focus on the task of completing the course. This exercise would be most effective if at least some of the stimuli were presented as food scents/smells and/or

Upon successful completion of each course the user 5 can be rewarded in any of the ways discussed above in relation to earlier arrangements, or in any other suitable manner. It may be that successful progression through each successive course level is sufficient incentive for the user 5 of this exercise.

It is to be appreciated that the above game can be modified in a number of ways to suit the particular training exercise and the user 5. For instance, the cyclist can be replaced by a car or other form of vehicle. If the user 5 is progressing well through the course and therefore exhibiting a high degree of goal shielding, they can be rewarded by way of extra fuel or greater acceleration etc. In other arrangements, the course itself may be dynamically modified depending on how well the user 5 successfully ignores the distracting stimuli. Hence, the course could become easier during the exercise (e.g. less holes, less bends etc.) as the user 5 continues to ignore the distracting influences. In this way, the user 5 can be actively rewarded during the exercise, providing a positive feedback to the user 5 on their performance. In such an arrangement, the response of the vehicle might also be improved to permit greater speed and/or manoeuverability.

Other suitable terrains and landscapes may alternatively be used, for instance, the game could be set on water and the user 5 must control a speedboat while avoiding the jaws of a surfacing shark etc. It is also possible that in some of the race game scenarios, the speed of the vehicle might be controlled by the game itself, so that the vehicle progresses at a substantially constant speed around the course. In this situation, progress around the course is then solely assessed on how effectively the user 5 responds to useful stimuli and ignores distracting ones. Again the degree to which the distracting stimuli are considered is a measure of how effectively the user 5 is shielding the goal.

Hence, it is to understood that the above examples represent only a few of the numerous different ways in which the present invention could be implemented via a game-like format, all of which employ the same paradigm of goal shielding training.

According to another aspect of the present invention which is consistent with all arrangements of the invention, the interface may also include, or be associated with, a sensor array 6 as shown in FIG. 1. By ‘associated’ we mean either physically connected by a hardwire link, wirelessly connected by wireless protocols (e.g. Bluetooth, WiFi), physically attached to the computing device 2 or else forming an integral part of the computing device 2.

The sensor array 6 preferably contains one or more biometric sensors, including a skin chemical/conductance monitoring sensor, a heart rate monitoring sensor and a user imaging device (e.g. CMOS or CCD camera). The use of biometric sensors provides an additional technique of monitoring the user's responses to the stimuli and therefore provides further means to assess the user's sub-conscious capacity to shield identified goals.

It is to be appreciated that any suitable sensor or sensor type may be used in the sensor array 6 in accordance with the present invention. In particular, remote physical monitors, such as accelerometers, may also be used to measure and determine any physical activity of the user 5 that may be prompted by one or more of the stimuli.

The sensors are able to monitor the user's sub-conscious reactions to presented stimuli, since for example, skin conductance, heart rate and eye movement etc. can all change rapidly in response to certain visual and/or audible stimuli. Hence, in accordance with the present invention, the client application 3 is configured to receive real-time data relating to physical attributes of the user 5, which may then be used in conjunction with the responses to the tests to determine whether the user's behaviour is consistent with shielding a particular goal.

In preferred arrangements, the sensor data from the sensor array 6 is provided to the client application 3, where it is then processed using standard algorithms (e.g. eye motion/posture recognition, heart rate calculation etc.) as appropriate, so that an assessment of the user's behaviour can be made and combined with the user's responses to the tests. In this way, both the sub-conscious and physiological responses of the user 5 to the stimuli can be monitored, thereby enabling the training exercises to be iteratively refined so as to optimise the effectiveness of the training for each particular user.

By ‘physical attributes’ we mean any physiological characteristics of an individual including, but not limited to, health indicators (such as heart rate, breathing pattern etc.), facial features (including eye movement, pupil dilation etc.), posture (e.g. head, shoulders), skin conductance, perspiration content and voice speech pattern (including intonation, grammar etc.).

The sensor array 6 is very useful when the interface 1 is presenting ‘game-like’ training exercises, as the imaging device can monitor the user's eye movements and head posture to determine whether the user 5 is being distracted from focussing on the course, e.g. road etc. Therefore, it becomes quite straight-forwarded to assess whether the user 5 is reading the transient messages (by virtue of lateral eye motion and/or head rotation) or whether they are staring at an object for an extended period, e.g. a billboard picture etc. In this way by monitoring the user's eye movements it is possible to determine whether, and to what extent, the user 5 is managing to reduce the time spent considering distracting stimuli.

In the race game scenarios this technique could be useful for differentiating between whether the user 5 is progressing around the course through improved skill/luck or whether they are effectively ignoring distracting stimuli. The sensor data concerning the user's skin conductance or heart rate could also be used in a similar way. Hence, for example, the skin conductance and heart rate could be monitored to determine whether the user 5 has been distracted by a picture or representation of a physically attractive person within the game.

Determining one or more physical attributes of the user 5 is also helpful in selecting which type of reward is most suited and effective for that person. For instance, if it is discovered that the user's heart rate increases rapidly in response to every stimulus, possibly indicative of a stressed or overly nervous disposition, then the client application 3 can select a rewards scheme which is more lenient on response time and in which the rewards offered are pleasantly calming, e.g. a piece of classical music, whale sounds or a picture of the countryside etc. Therefore, as discussed earlier, the interface 1 can actively adapt the training exercises to the characteristics of the user 5, so as to better increase the overall effectiveness of the goal shielding training.

In accordance with the present invention, the user 5 is able to select appropriate training exercises dependent on their particular identified goal or goals. Hence, for example, if the user 5 wants to get fit they can then choose one or more exercises which are designed to improve the user's ability for shielding the goal of getting fit.

If the client application 3 determines that no suitable training exercises are available locally on the computing device 2, it can request a download from the remote server 3, via a communications session established across a wireless network 7. The wireless network 7 may be any suitable wireless communications network, which in the case of mobile phone applications would typically be a cellular telecommunications network.

Preferably, a communication session with the remote server 3 is established via the network 7 using conventional handshaking protocols, and a server application 8 on the server 4 handles all requests for training exercises

The requests may be in any suitable file or message format, such as text based formats, ASCII text, HTML and XML etc. and may be compressed to shorten transmission time etc.

The server application 8 is preferably implemented using any suitable programming language and is preferably platform/operating system independent, so as to ease portability of the application to different architectures and systems. In preferred arrangements, the server application 8 includes at least one content database 9, which is configured to store test related content such as training exercises and scoring algorithms etc. that may be downloaded on demand.

In some arrangements, the computing device 2 may include location tracking means, preferably a global positioning system (GPS) based transceiver, which is able to determine the location of the user 5 and provide location data to the client application 3. Having knowledge of the user's whereabouts can be useful, as the training exercises may be specifically adapted to the particular location so that environmental influences and conditions can be utilised together with the series of stimuli.

In accordance with all arrangements of the present invention, the interface 1 in addition to training the user 5 also comprises means for assessing the progress and development of the user as the training continues. In other words, the efficacy of the training can be measured using a standard goal-shielding task before and after the training exercises. One preferred task involves requesting that the user 5 differentiate between word and non-word targets. For example, the non-word targets are letter strings that are able to be pronounced, e.g. suvatik, while the word targets comprise three different types: (a) words related to conflicting goals (e.g. sleep, relax, drink, smoke), (b) words related to identified goals (e.g. fitness, diet, healthy) and (c) words which are neutral (e.g. sky, river, mountain)

Each word in the test, being one of either type (a), (b) or (c), is presented to the user 5 via the display means of the computing device 2. However, prior to showing the word, a symbol which is preferably a ‘fixation cross’ is shown for about 1 second and is then immediately replaced by an exercise or neutral prime. Use of a fixation cross is known to enable the user 5 to focus on the location where the prime is to be displayed. This is so that the measured reaction time of the user does not also include any time required for the user 5 to focus on that location of the display. In other words, at the moment the prime is displayed the user 5 is already looking at that point on the display.

The prime is preferably displayed for about 42 ms, which is short enough to be outside of the user's conscious mental awareness and is therefore only sub-consciously acknowledged by the user 5. However it is to be appreciated that any suitable display time for the prime may be used. The function of the prime is to effectively activate the identified goal within the user's sub-conscious memory, i.e. to trigger the concept associated with the goal within the user's mind. The thought processes behind the goal are then sub-consciously accessible to the user for use in the next step of the test.

The prime is immediately replaced by a mask, such as a string of Xs e.g. XXXXXXXXXX. However, any suitable form of ‘blanking’ can be used. This is to ensure that the prime is not imprinted on the retina of the user (via inherent persistence of vision) and processed for greater than the intended time. If this were to occur, it would result in the prime being processed at a conscious level rather than a sub-conscious level, thereby biasing the results.

The mask is preferably displayed for about 681 ms, at which point the mask is replaced by the target word. The mask is made longer than any of the primes or target words.

This procedure is followed for each target word and the words remain on the display until the user 5 makes a response. It is found that users who are effective at goal shielding have slower response times to words which are associated with competing goals, i.e. type (a) words. Hence, by measuring the response times to the type (a) words, it is possible to determine how effective the user is at shielding goals, which when implemented with the training exercises of the present invention, enables the user's progress to be accurately assessed throughout the training.

The assessment of the user's progress can be used by way of feedback to the client application 3, which can further adapt the subsequent training exercises so as to better improve the efficacy of the training.

It is to be appreciated that the above procedure is only one example of how the efficacy can be assessed and therefore any other-suitable technique may be used in conjunction with the interface 1 of the present invention.

The above masking technique also has application in the game-based scenarios of the present invention. This is to ensure that the distracting stimuli are not mentally processed by the user 5 at a conscious level. Hence, appropriate masking could be used in conjunction with the billboard signs or other aspects of the virtual environment. For example, as,a billboard sign is approached a tree, lamp-post or building could obscure it after the message/picture has been displayed for a short interval of time, consistent with the time periods t₁, t₂ of the word categorisation test. Alternatively, the message/picture could be obscured by ‘reflected sunlight’ to artificially emulate sunlight being bounced of the planar surface of the billboard etc. as the vehicle passes by. Of course any other suitable technique could be used.

Although the present invention is ideal for training and improving a user's ability to shield identified goals via use of a computer interface implemented on various devices, it will be recognised that one or more of the principles of the invention could be used in other applications, for instance, in any computer-based training scenario in which a reward system is contingent upon successful performance in relation to a series of tests.

Other embodiments are taken to be within the scope of the accompanying claims.

1. A method of operating a computer interface for interacting with a user to improve the user's ability to shield an identified goal, comprising:
presenting the user with a series of stimuli, each stimulus suitable for prompting a response from the user;
monitoring the user's responses to the stimuli;
determining, as a function of the responses, whether the user's behaviour is consistent with shielding the goal; and
presenting the user with one or more rewards dependent on the degree of shielding exhibited by the user.

2. The method of claim 1, wherein monitoring includes monitoring any responses made within (i) a first period of time t₁, (ii) a second period of time t₂, following the first period, or a (iii) third period of time t₃, following the second period.

3. The method of claim 1, wherein a correct response made within the first period of time t₁ gains the highest reward, a correct response made within the second period of time t₂ gains a reduced reward and any response made within the third period of time t₃ gains no reward.

4. The method of claim 1, wherein presenting the stimuli involves displaying at least some of them visually to the user.

5. The method of claim 1, wherein monitoring the user's responses involves determining the time taken to respond to each stimulus.

6. The method of claim 1, wherein monitoring the user's responses includes monitoring one or more physical attributes of the user.

7. The method of claim 6, wherein the rewards are selected on the basis of the one or more physical attributes of the user.

8. The method of claim 1, wherein determining includes making an assessment of the user's sub-conscious capacity to shield the goal.

9. The method of claim 8, wherein the assessment involves assessing the user's behaviour in response to the stimuli.

10. The method of claim 1, wherein the series of stimuli correspond to words in a word categorisation test.

11. The method of claim 10, wherein the user's responses involve categorising the words into one of two different categories.

12. The method of claim 10, wherein the rewards correspond to points awarded for the correct categorisation of words within predetermined response time periods.

13. The method of claim 12, wherein the response time periods are varied as a function of the user's responses.

14. The method of claim 12, wherein the response time periods elapse at a time-out limit.

15. The method of claim 10, further comprising prompting the user to calculate a numerical score based on the results of the word categorisation test.

16. The method of claim 1, further comprising presenting the stimuli within a game-like virtual environment.

17. The method of claim 16, wherein the virtual environment contains a plurality of visual and/or audible stimuli for prompting a response from the user.

18. The method of claim 16, wherein at least some of the plurality of stimuli correspond to distracting stimuli and wherein the step of monitoring the user's responses includes determining the time spent considering one or more of the distracting stimuli.

19. The method of claim 16, further including the step of masking one or more of the distracting stimuli after a predetermined period of time for prompting a sub-conscious response from the user.

20. The method of claim 1., further comprising:
presenting the user with a first task prior to presenting the series of stimuli; and
presenting the user with a second task following the step of presenting the one or more rewards to the user;
wherein the first and second tasks are selected to assess the user's capacity to shield the identified goal.

21. A computer interface for interacting with a user to improve the user's ability to shield an identified goal, comprising:
means for presenting the user with a series of stimuli, each stimuli suitable for prompting a response from the user;
means for monitoring the user's responses to the stimuli;
means for determining, as a function of the responses, whether the user's behaviour is consistent with shielding the goal; and
means for presenting the user with one or more rewards dependent on the degree of shielding exhibited by the user.

22. The computer interface of claim 21, wherein the monitoring means includes means for monitoring any responses made within (i) a first period of time, (ii) a second period of time, following the first period, or a (iii) third period of time, following the second period,
wherein a correct response made within the first period gains the highest reward, a correct response made within the second period gains a reduced reward and any response made within the third period gains no reward.

23. The computer interface of claim 21, wherein the interface is implemented on a mobile computing device.

24. The computer interface of claim 21, wherein the mobile computing device is one of the following devices: a mobile phone, a laptop, a PDA and a tablet PC.

25. The computer interface of claim 21, wherein the mobile computing device comprises one or more biometric sensors for determining physical attributes of the user.

26. The computer interface of claim 21, wherein the interface is implemented within a web browser environment.

27. The computer interface of claim 21, further comprising means for communicating with a remote server to exchange information between the interface and the server.

28. A remote server for communicating with a computer interface, comprising:
means for receiving information from the computer interface;
storage means configured to store test related content; and
means for selecting one or more of the test related content, based on the received information, to be downloaded to the computer interface for improving the goal shielding ability of a user using the interface.

29. The remote server of claim 28, wherein the storage means is further configured to store the user's test results received via the receiving means.

30. Apparatus as described substantially herein with reference to the accompanying figures.
